(19) United States
(12) Patent Application Publication
(10) Pub. No.: US 2017/0053352 A1
(43) Pub. Date: Feb. 23, 2017

(54) COMMUNITY-CENTRIC FAÇADES FOR INFORMATION EXCHANGE PLATFORM

(71) Applicant: Open Text GXS ULC, Halifax (CA)

(72) Inventor: Sean Patrick Hill, Frederick, MD (US)

(21) Appl. No.: 15/241,588

(22) Filed: Aug. 19, 2016

Related U.S. Application Data
(60) Provisional application No. 62/207,731, filed on Aug. 20, 2015.

(51) Int. Cl. G06Q 40/04

(52) U.S. Cl. CPC G06Q 40/04

(57) ABSTRACT

A method of façade management may include receiving a request containing identifying information from an operating unit. Identifying information contained in the request may be processed to determine at least one trading partner of the operating unit. A solution community may be created for the operating unit, the solution community containing the operating unit and at least one trading partner of the operating unit in the solution community. Master data associated with the operating unit may be created along with a façade for each of the at least one trading partner. A trading partner graph containing solution communities and nodes representing operating units and relationships amongst the operating units may be updated to include the newly created master data and façades.

### CROSS-REFERENCE TO RELATED APPLICATION(S)

This is a conversion of, and claims a benefit of priority from U.S. Provisional Application No. 62/207,731, filed Aug. 20, 2015, entitled “COMMUNITY-CENTRIC FACçADES FOR INFORMATION EXCHANGE PLATFORM,” the entire disclosure of which is fully incorporated by reference herein, including the appendixes.

### TECHNICAL FIELD

This disclosure relates generally to supply chain integration, synchronization and collaboration solutions. More particularly, this disclosure relates to an information exchange platform providing operating units with supply chain integration, synchronization and collaboration solutions. Even more particularly, this disclosure relates to systems, methods, and computer program products for providing façades that can be used and controlled by these operating units in describing their partners within the information exchange platform operating in a network computing environment.

### BACKGROUND OF THE RELATED ART

Today, enterprises and entities alike recognize the tremendous cost savings be exchanging business documents with their trading partners via an electronic communication method referred to as the Electronic Data Interchange (EDI). An electronic information exchange platform may provide various services to networked enterprise systems so that documents such as invoices, purchase orders, etc. can be exchanges over a network, for instance, using the EDI. Skilled artisans appreciate that such an electronic information exchange platform has the necessary resources (e.g., hardware, software, personnel, etc.) to provide services that enable the real-time flow or exchange of information electronically in a networked environment.

In exchanging information via the electronic information exchange platform, it can be important to correctly and accurately identify sending and receiving entities, for instance, utilizing a description associated with an EDI that describes a receiving entity. However, each entity may have their own way of describing themselves as well as other entities. For example, entity A may be described one way by entity B and another way by entity C. Further, entity A may have its own way of describing itself. Accordingly, an entity may be inconsistently described by other entities with which information is exchanged via the electronic information exchange platform. Such inconsistences present a challenge for the electronic information exchange platform to reconcile the various descriptions and correctly and accurately identify entities involved in an information exchange. Even if the descriptions provided by these entities could be reconciled, it is not possible for the electronic information exchange platform to modify the descriptions as the entities maintain control of their own data.

### SUMMARY OF THE DISCLOSURE

Embodiments of a system disclosed herein provide supply chain integration, synchronization and collaboration services through an information exchange platform having the necessary resources (e.g., hardware, software, personnel, etc.) to enable the real-time flow or exchange of information between operating units such as enterprises, corporations, companies, agencies, etc. OpenText GXS Trading Grid® (hereinafter referred to as the Trading Grid or TG) is an example of an information exchange platform that operates in a cloud computing environment.

In some embodiments, a method of façade management may include receiving a request from an operating unit, processing identifying information contained in the request to determine at least one trading partner of the operating unit, creating a solution community containing the operating unit and the at least one trading partner of the operating unit, with the operating unit designated as an owner of the solution community. In some embodiments, the identifying information comprises at least one electronic data interchange (EDI) address of a trading partner of the operating unit.

The method may further include creating master data associated with the operating unit. The master data comprises global master data and façade data. Specifically, the master data may include a master data object for the operating unit and a façade for each of the at least one trading partner of the operating unit in the solution community. Such a façade may reference the master data object and include configuration information specific to the solution community. The community-specific configuration information in the façade, which is owned by the operating unit and which describes a trading partner of the operating unit from the perspective of the operating unit in context of the solution community, may be required for computer-to-computer interchange of formatted messages between the operating unit and the at least one trading partner.

The method may also include updating a trading partner graph stored in a database. The trading partner graph contains solution communities and nodes representing operating units and relationships amongst the operating units with respect to the solution communities. The master data object represents the operating unit in the trading partner graph. The global master data associated with the operating unit do not change across the solution communities. However, the façade data are community-specific.

In some embodiments, the method may include projecting facts about the operating unit provided by the operating unit into a façade that is in a different solution community owned by a different operating unit that is a trading partner of the operating unit. Although the façade describes the operating unit in that solution community, it may contain incorrect information about the operating unit, since it describes the operating unit from the perspective of its trading partner. This projection, if permitted by the trading partner, allows the operating unit to control how they should be described in a façade that they do not own. Such a projection can be done at the façade level or at the element level within a façade. In some embodiments, the method may include overriding a value contained in a façade. Overriding the value contained in the façade may be triggered by a request from an operating unit or trading partner being described in the façade.

In some embodiments, a method of façade management may include generating a first community of entities and a second community of entities. Each of the entities may have attributes. The first community of entities may comprise a first central entity and a first associated entity having a relationship with the first associated entity that defines first computer transactions with the first central entity. The second community of entities may comprise a second central entity and a second associated entity having a relationship with the second associated entity that defines second computer transactions with the second central entity.

The method may further include comparing the associated entities of the first and second community and based on the comparison determining that the first and second associated entities have matching attribute pairs. In some embodiments, this determination may comprise referencing a list of predefined attribute values. Based on the determination, a master common entity may be generated by merging the first associated entity and the second associated entity. The master common entity may have a relationship with the first and second central entity comprising at least a portion of the first and second computer transactions, respectively.

A first and second façade entry may be generated comprising at least one attribute of the first and second community of entities, respectively. The first façade entity may reference the first central entity and the master common entity while the second façade entity may reference the second central entity and the master common entity. The master common entity may comprise attributes based on said merging of the first associated entity and the second associated entity

In some embodiment, the first and second computer transactions may comprise computer-to-computer interchange of formatted messages. The method may, in some embodiments, also include comparing the attributes of the first associated entity and the second associated entity; and determining that attributes are the same.

Each of the entities may be assigned a unique identifier and the first computer transactions and the second computer transaction occur according to the unique identifier. In some embodiments, the unique identifier comprises an electronic data interchange (EDI) address.

The method may further include merging the first associated entity and the second associated entity by performing a comparison of a first attribute of the first associated entity to a second attribute of the second associated entity, the second attribute corresponding to the first attribute and generating an attribute of the master common entity based on said comparison. In some embodiments, the method may further include copying the first attribute to the first façade entity and the copying the second attribute to the second façade entity, thereby preserving each attribute. As the first attribute and the second attribute may be different, the attribute of the master common entity may represent a merged common attribute corresponding to the first attribute and the second attribute. In some embodiments, the master common entity may be generated by omitting a portion of the first attribute or the second attribute.

In one embodiment, the system may comprise at least one processor, at least one non-transitory computer-readable storage medium, and stored instructions translatable by the at least one processor to perform a method substantially as described herein. Another embodiment comprises a computer program product having at least one non-transitory computer-readable storage medium storing instructions translatable by at least one processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1A depicts a diagrammatic representation of an example of a supply chain network having a plurality of operating units in accordance with one embodiment.

FIG. 1B depicts a diagrammatic representation of an example of a trading partner graph illustrating the relationships of the plurality of operating units in the supply chain network shown in FIG. 1A.

FIG. 2 depicts a diagrammatic representation of an example of a system operating on an information exchange platform and its relationships with operating units in accordance with one embodiment.

FIG. 3 depicts a diagrammatic representation of an example of a system having community-centric façades for operating units in accordance with one embodiment.

FIG. 4 depicts a diagrammatic representation of an example of a solution community architecture in accordance with one embodiment.

FIG. 5 depicts a diagrammatic representation of an example of a solution community architecture in which each operating unit in a solution community may own a façade that describes a trading partner in the solution community.

FIG. 6 depicts a diagrammatic representation of another example of a solution community architecture in which each operating unit is the center of a solution community.

FIG. 7 depicts a diagrammatic representation of an example of an operating unit projecting facts about themselves into their trading partner's façade that describes them.

FIG. 8 depicts a diagrammatic representation of an example of a façade data structure.

FIG. 9 depicts a diagrammatic representation of an example of a network environment where embodiments disclosed herein may be implemented.

FIG. 10 is a flow diagram illustrating an example of a method performed by an embodiment of a system disclosed herein.

FIG. 11 depicts a diagrammatic representation of an example of a system in accordance with one embodiment disclosed herein.

FIG. 11A and FIG. 11B depict entity tables used by the system of FIG. 11 in accordance with one embodiment disclosed herein.

FIG. 12 depicts a diagrammatic representation of an example of a computing environment where embodiments disclosed may be implemented.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As discussed above, embodiments provide a system operating on an information exchange platform. The system includes a plurality of document-centric applications for facilitating the real-time flow or exchange of information between operating units regardless of standards preferences, spoken languages, or geographic locations. For example, a portion of the plurality of document-centric applications may provide managed services such as document tracking, messaging, document transformation, regulatory compliance, encryption, data manipulation, etc.

In this disclosure, the term “document-centric applications” refers to a class of applications configured to run on the information exchange platform and provide at least one of the following capabilities:
1) Facilitate the electronic exchange of documents among two or more operating units (referred to herein as trading partners or TPs), by:
   a. Allowing the Sender TP to submit, or the Recipient TP to receive, a document via any of the supported communication protocols. Usually, these exchanges are performed “machine to machine”.
   b. Transforming the source document(s) from a Sender TP into one or more documents in a format understood by the Recipient TP(s).
   c. Allowing a Person ascribed to a TP to enter, edit, validate, send or receive a document using forms via web or mobile browsers.
2) Archival (persistent storage) and retrieval of documents.
3) Document encryption/decryption/tokenization for transfer or storage.
4) Document-centric logic for functions like:
   a. Validate the quality, completeness, accuracy or integrity of a document against a set of rules
   b. “Turn-around” a document of a given type into a pre-filled document of a derived document type, for example, to turn an Order into an Invoice.
   c. Common transaction functions for a given document type, for example, signature of an Invoice, currency conversion of an Order.
5) Search and filter a collection of documents.
6) Orchestrate end-to-end global transaction processes by orchestrating its constituent document exchanges (process strands).
7) Provide visibility into the document exchange process, including monitoring and alerting for exception conditions, that is comprehensive Operational Analytics.
8) Provide facilities for deep introspection of Documents for deriving transaction analytics, including reporting, ad-hoc querying and predictive analytics.
9) Service application programming interfaces (APIs) to access and extend programmatically the application functionality

A “document” in this context refers to the encoding of information in digital form for the purpose of exchanging the information with another party. The encoding of the document may also include meta-data about its content, destination, operational parameters, permissions, etc. Examples of documents in this context can include electronic data interchange (EDI)-encoded formats, all of the traditional office formats (Word, Excel, PowerPoint, etc.), computer-aided design and computer-aided manufacturing (CAD/CAM) files, multimedia content including video, and even content that could be provided by a device participating in an Internet of Things network. Skilled artisans appreciate that EDI is an electronic communication method that provides standards for exchanging data via any electronic means and that is defined as the computer-to-computer interchange of formatted messages by agreed message standards. EDI distinguishes mere electronic communication or data exchange in that in EDI, the usual processing of received messages is by computer only. By adhering to the same message standard, TPs, even in two different countries, can electronically exchange documents (e.g., purchase orders, invoices, acknowledgement, notices, etc.).

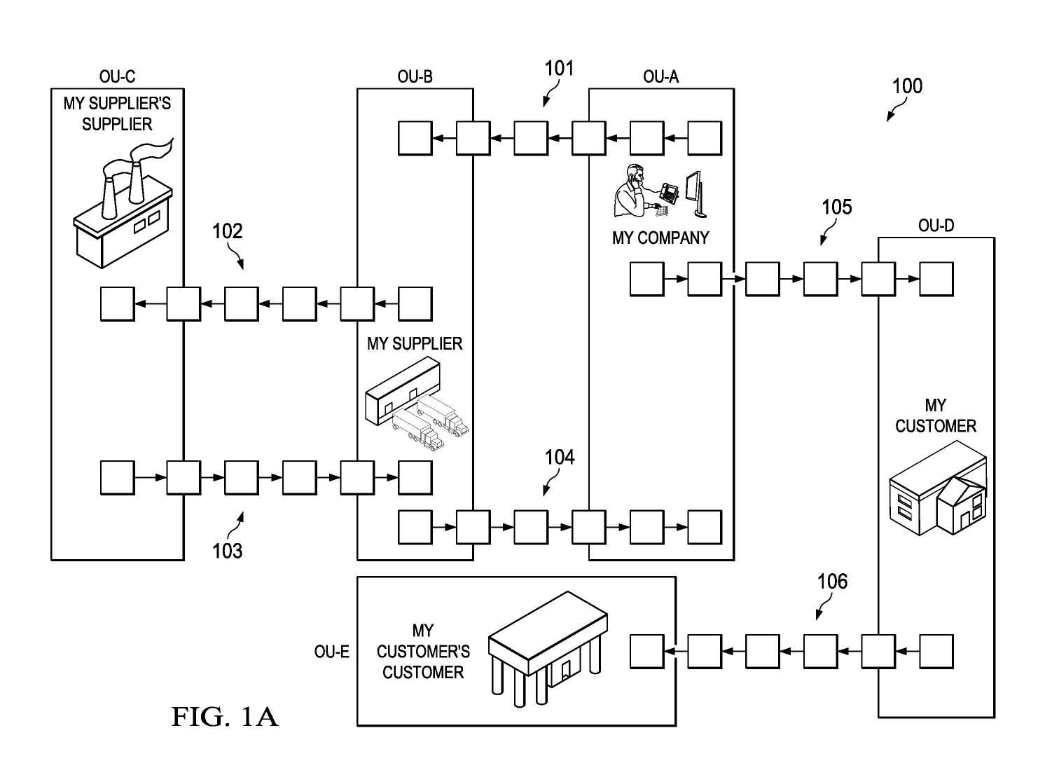

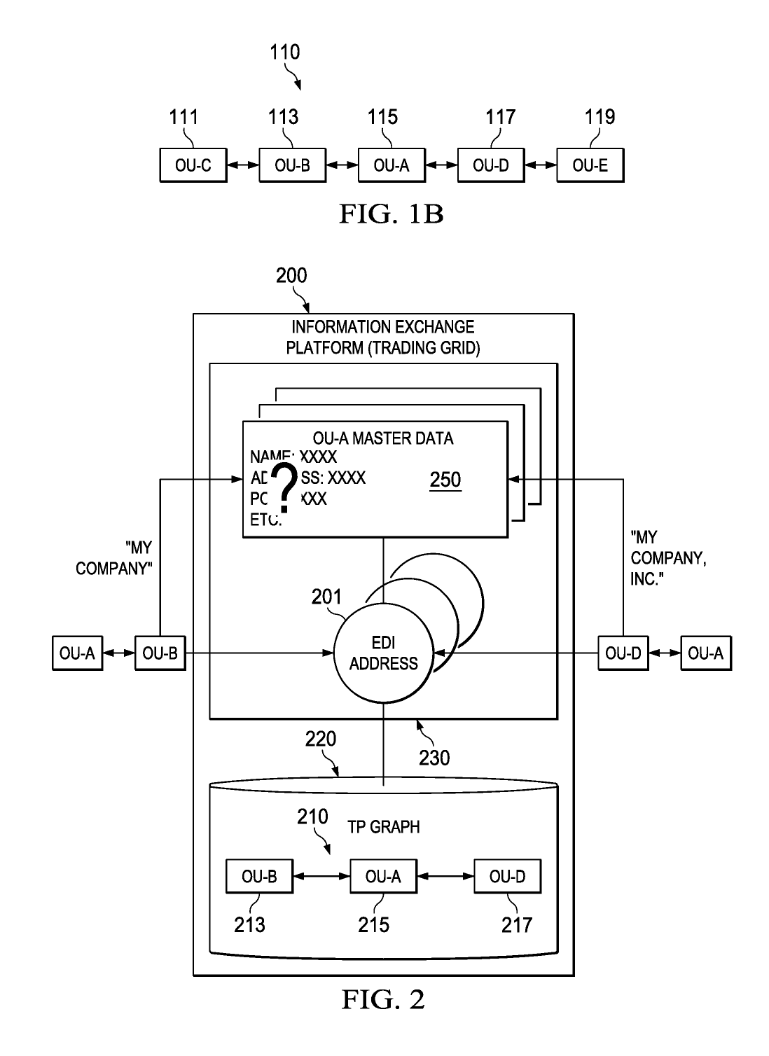

In a supply chain network, documents represent the “information supply chain” that mirrors the physical supply chain, acting as proxies for the actual physical goods or actions of a commercial transaction. In some cases, a document can be the actual good that is being transacted. For example, in a digital supply chain in areas like media, collaborative design, gaming, financial instruments, etc., a document often is the actual good that is being transacted. An example of a supply chain network is illustrated in FIG. 1A.

As illustrated in FIG. 1A, supply chain network 100 may include a plurality of operating units (OUs) including “My Company” (OU-A), “My Supplier” (OU-B), “My Supplier's Supplier” (OU-C), “My Customer” (OU-D), and “My Customer's Customer” (OU-E). In this disclosure, an operating unit (OU) represents a company, a corporation, an enterprise, an entity, or a division thereof.

Notice that in FIG. 1A, supply chain network 100 reflects a perspective of OU-A “My Company.” That is, on the one hand, OU-A may have specific knowledge about OU-B and OU-D because OU-B and OU-D are TPs of OU-A. On the other hand, OU-A may know of OU-C through OU-B, a supplier of OU-A, but OU-A may not have specific knowledge about OU-C. Likewise, OU-A may know of OU-E through OU-D, a customer of OU-A, but OU-A may not have specific knowledge about OU-E. Therefore, the levels of knowledge that OU-A may have about each OU in supply chain network 100 may vary greatly from OU to OU.

As an example, suppose in building a product OU-A may need an item (or a part) of which OU-B is a supplier. Accordingly, OU-A may send an Order (a type of document supported by supply chain network 100) to OU-B (101). As explained below, this communication may be accomplished via a system operating on an information exchange platform such as the Trading Grid disclosed herein. OU-B, which is a TP of OU-A, may receive the Order from OU-A and work to fulfill the Order from OU-A. In doing so, OU-B may need one or more items from OU-C. Accordingly, OU-B may send an Order (which may or may not combine the Order from OU-A with any other Order from any of OU-B's own TPs) to OU-C (102). OU-C, in this case, is a TP of OU-B, but not a TP of OU-A. OU-C fulfills the Order from OU-B (103) which, in turn, fulfills the Order from OU-A (104). OU-A then completes and provides the product to its customer, OU-D (105). OU-D, which is a TP of OU-A, may use the product from OU-A to fulfill an Order from its own customer, OU-E (106). OU-E, in this case, is a TP of OU-D, but not a TP of OU-A.

FIG. 1B depicts a diagrammatic representation of an example of a trading graph 110 having nodes 111, 113, 115, 117, and 119 illustrating the relationships of the OUs in supply chain network 100 shown in FIG. 1A. As illustrated in FIG. 1B, although both OU-B and OU-D are direct TPs of OU-A, they are not direct TPs with each other and only know of each other through OU-A. Therefore, neither OU-B nor OU-D may have specific knowledge about each other. Likewise, although both OU-C and OU-A are direct TPs of OU-B, they are not direct TPs with each other and only know of each other through OU-B. Therefore, neither OU-C nor OU-A may have specific knowledge about each other. Similarly, although both OU-A and OU-E are direct TPs of OU-D, they are not direct TPs with each other and only know of each other through OU-D. Therefore, neither OU-A nor OU-E may have specific knowledge about each other.

For the purpose of illustration, FIGS. 1A-1B show supply chain network 100 with only five OUs. Skilled artisans appreciate that a supply chain network may involve hundreds or even thousands of OUs. Therefore, potential relationships amongst OUs in a supply chain network can be quite complex and complicated. Moreover, relationships amongst the OUs in a supply chain network can change rapidly and significantly. As can be expected, it can be very challenging for a system operating on an information exchange platform to keep track of relationships in a supply chain network so that the system can facilitate the real-time flow or exchange of information between these OUs in a supply chain network. Further complicating the matter is that the system may need to support multiple supply chain networks and multiple OUs may be involved in any one of the multiple supply chain networks that the system supports.

According to embodiments, a Trading Partner Graph (TP Graph) is a representation of all of the Trading Grid OUs, their TPs, and the relationships between them. It is the superset of OUs and their trading relationships. Each OU may be represented in a TP Graph by a single node. Referring to FIG. 1B as an example, if OU-B and OU-D both trade with OU-A, they are trading with the same OU-A instead of two separate nodes that share a similar name. However, not all OUs in a TP Graph may be registered with the system. Furthermore, OUs may join the system at different times. Thus, the TP Graph may not represent a complete supply chain network. Rather, it represents OUs, their TPs, and their relationships in the Trading Grid supported by the system. This is further explained below.

Related to each OU in the TP Graph is one or more unique identifiers (e.g., routing/EDI addresses). When the system implements a particular OU, the system receives a list of TPs from the particular OU in the form of unique identifiers (e.g., EDI addresses) uniquely identifying the TPs. If a new TP is added to the TP Graph, the system searches the unique identifier associated with the new TP to determine if the TP already exists. If so, the new TP is added as a new relationship to an existing community. If the TP does not already exist, a new node is created and added to the existing solution community. Optionally, the list of TPs may also include company names. Often these names/addresses relate to the particular OU's TPs that are external to the system. Therefore, the system may or may not have direct relationships to all of the TPs in the TP Graph.

For example, referring to FIG. 2, a TP Graph 210 having nodes 213, 215, and 217 representing OU-B, OU-A, and OU-D and their relationships is stored in a database 220 of system 230 operating on an information exchange platform (Trading Grid) 200. In this example, OU-B has a trading relationship with OU-A and a direct relationship with system 230. However, OU-A has no direct relationship with system 230 and therefore is external to system 230. Accordingly, from the perspective of system 230, all the knowledge about OU-A, stored in system 230 as master data 250, is from OU-B. Suppose OU-D forms a direct relationship with system 230 and sends system 230 a list of TPs. The list of TPs from OU-D contains an EDI address 201 that is the same as the EDI address provided by OU-B for OU-A. However, OU-B identifies OU-A as “My Company” and OU-D identifies the same EDI address as being associated with “My Company, Inc.”. Since both OU-B and OU-D are trading with the same node 215 according to TP Graph 210 (which system 230 uses to provide services to OU-B and OU-D), the inconsistency has to be resolved without creating a second OU for EDI address 201. To resolve this inconsistency, some factors that need to be considered may include:
What are the options to resolve the inconsistency?
Should the name for OU-A be changed to accommodate the newly joined OU-D?
If the name for OU-A should be change, how would that impact OU-B?
If the name for OU-A should not be changed, should OU-D live with the name for OU-A provided by OU-B?
Should additional name fields be added for each potential variant of the name?
Who decides what OU-A's name is when OU-A itself is unable/unwilling to manage its own master data?

At issue is that neither OU-B nor OU-D is an authoritative source of information about OU-A—an OU that is external to system 230. Since system 230 has no direct relationship with OU-A, it is not an available option for OU-A to take ownership of their own master data 250 in system 230 and settle the discrepancy. Sometimes an EDI address is all system 230 has to represent an external OU in TP Graph 210.

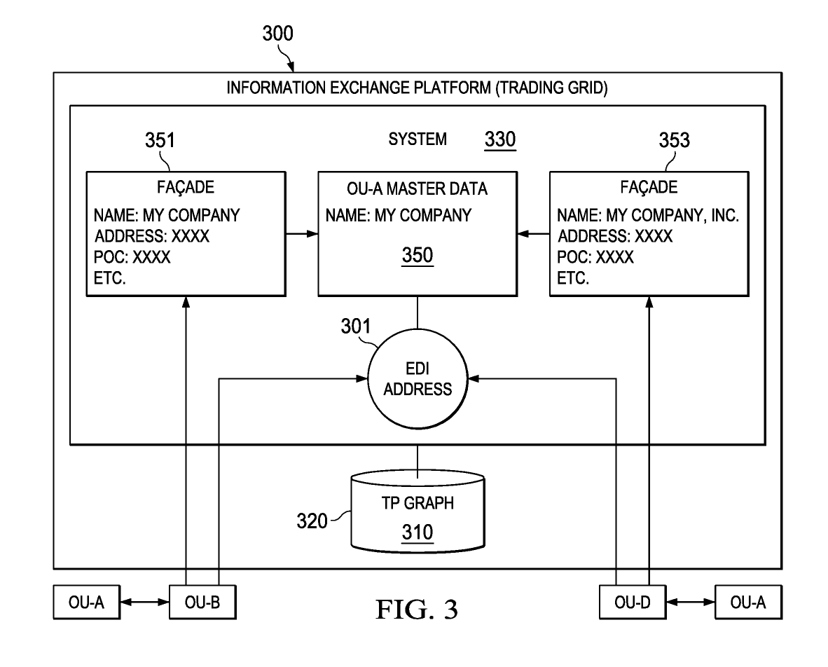

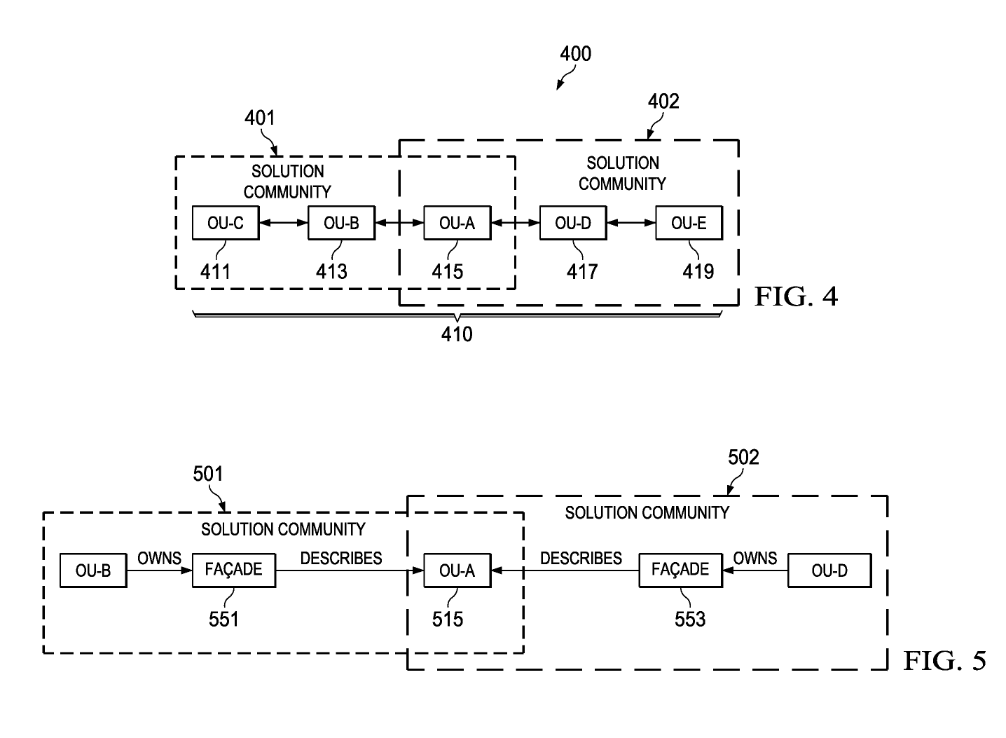

To address this issue, OU-B and OU-D could be allowed to each own and maintain a profile record (referred to herein as a façade) for OU-A. FIG. 3 depicts a diagrammatic representation of an example of a system 330 operating on an information exchange platform 300. For the purpose of illustration, and not of limitation, system 330 is shown with a basic form of a façade pattern, with OU-B having a façade 351 for OU-A and OU-D having a façade 353 for OU-A. Both façade 351 and façade 353 point to master data 350 of OU-A which has a unique identifier, EDI address 301, and which is represented in a TP Graph 310 (which in this example is stored in a database 320) as a single node. Even this basic form of a façade pattern can lead to some interesting possibilities. To better understand the possibilities, FIG. 4 shows by example a solution community architecture.

As illustrated in FIG. 4, a supply chain network 400 may be represented by a TP Graph 410 having nodes 411, 413, 415, 417, and 419. Additionally, supply chain network 400 can be seen as having a solution community 401 with OU-B being the center of solution community 401 and having two TPs: OU-A and OU-C; and a solution community 402 with OU-D being the center of solution community 402 and having two TPs: OU-A and OU-E. From the perspective of OU-B, solution community 401 is all about them. They have no visibility to OUs outside of solution community 401. That is, OU-B does not have visibility to solution community 402 and does not have visibility to relationships in which they have no role. Likewise, from the perspective of OU-D, solution community 402 is all about them. They have no visibility to OUs outside of solution community 402. That is, OU-D does not have visibility to solution community 401 and does not have visibility to relationships in which they have no role.

Accordingly, in this disclosure, a solution community represents a subset of the overall TP Graph from the perspective of a single OU (e.g., solution community 401 is a subset of TP Graph 410 from the perspective of OU-B and solution community 402 is a subset of TP Graph 410 from the perspective of OU-D). Thus, from a system perspective, multi-tenancy in a Trading Grid can be represented by the combination of many solution communities, each of which appears as a single-tenant to the respective community owners. In the case of OU-B, solution community 401 consists of all of OU-B's relationships to their TPs and services provided by the system that can be applied to those relationships. Similarly, in the case of OU-D, solution community 402 consists of all of OU-D's relationships to their TPs and services provided by the system that can be applied to those relationships. It is important to note that neither OU-B nor OU-D owns their TPs' nodes in the TP Graph used by the system, but only their relationships with their TPs.

More specifically, each OU may own their own façade(s) to describe their TP(s) in their solution community. This is illustrated in FIG. 5 where OU-B owns a façade 551 that describes their TP OU-A in a solution community 501 and where OU-D owns a façade 553 that describes their TP OU-A in a solution community 502. Both façade 551 and façade 553 point to the same node 515 representing OU-A in a TP Graph (not shown) that the system maintains and uses to provide services to OU-B and OU-D.

In some embodiments, a façade can be implemented as an instance (also called an instance object) of a master data object associated with a particular OU. An instance is a specific realization of an object. Thus, a façade has a particular value (realization) and reflects the distinct identity of the master data object. For example, referring back to FIG. 3, when EDI address 301 is first provided to system 330 (e.g., via OU-B), system 330 may automatically create a master data object 350 and façade 351, both of which represent OU-A.

In the example illustrated in FIG. 3, master data object 350 may include a data structure having at least a data field “Name” which has a value of “My Company”. Likewise, façade 351 may include a data structure having data fields including a data field “Name” having a value of “My Company” (based on the information that OU-B provided to system 330). Master data object 350 represents OU-A from the perspective of system 330 and may include EDI address 301 and any configuration information pertaining to OU-A, including services provided by system 330 for OU-B to communicate with OU-A. Façade 351 represents OU-A from the perspective of OU-B and contains a pointer that references master data object 350. Additionally, façade 351 includes information describing OU-A (e.g., name, address, point of contact or POC, etc.) and their relationship (e.g., OU-B is a supplier of OU-A).

When OU-D forms a direct relationship with system 330 and sends system 330 a list of EDI addresses, system 330 may process the list of EDI addresses received from OU-D, determine that the list of EDI addresses contains EDI address 301 already associated with OU-A, access master data object 350 associated with OU-A to obtain necessary information (e.g., the memory location where master data object 350 is stored), and use the obtained information to instantiate façade 353 such that façade 353 references master data object 350. In this case, façade 353 represents OU-A from the perspective of OU-D and includes information describing OU-A (e.g., name, address, point of contact or POC, etc.) and their relationship (e.g., OU-D is a customer of OU-A). To OU-D, the name of OU-A is “My Company, Inc.”. However, to OU-B, the name of OU-A is “My Company.” The façade architecture illustrated in FIG. 3 allows both TPs of OU-A to describe OU-A in their own way. Those skilled in the art can appreciate that any suitable data models may be used to implement the data structure needed to create a master data object (e.g., master data object 350) and façades thereof (e.g., façades 351 and 353). Some examples are provided below with reference to FIG. 8. In some embodiments, system 330 may update master data object 350 to include information about OU-A received from OU-D and/or services provided by system 330 for OU-D to communicate with OU-A.

According to embodiments, façade owners (e.g., OU-B and OU-D in the example of FIG. 3) can control what is stored in façade records describing their TPs. In some embodiments, such as those implementing a Software as a Service (SaaS) delivery model in a solution community, the system may automatically add a block of elements to a façade. For example, when a solution community owner adds a new service provided by the system, a block of elements representing legal profiles associated with the new service could be added to façades of affected partners.

The master data may be thought of as “default” data—the data that can be used for all solution communities in the absence of a façade. When a façade is created in a solution community, however, the façade overrides this default data for that solution community. Since façades belong to an OU, and since they describe that particular OU's TPs in a solution community, they are an artifact of the solution community itself. This fact can play an important role in addressing data sovereignty concerns.

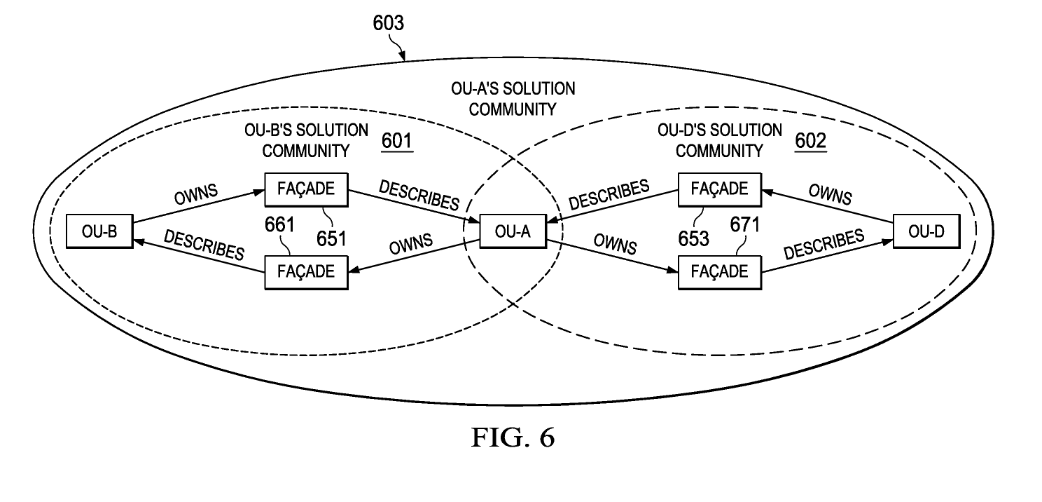

For example, should OU-A form a direct relationship with the system and be provided with a solution community of their own, they would be treated by the system as the center of a TP Graph universe as defined by the particular solution community. This is illustrated in FIG. 6. In the example of FIG. 6, OU-A is the center of a TP Graph universe as defined by a solution community 603, with OU-B and OU-D as TPs of OU-A. Similar to the example above, OU-B and OU-D each has its own solution community. In this case, OU-B is the center of a TP Graph universe as defined by a solution community 601, with OU-A as a TP of OU-B. Likewise, OU-D is the center of a TP Graph universe as defined by a solution community 602, with OU-A as a TP of OU-D. Each OU maintains a façade for each of their TP in their own solution community. In this case, OU-B owns a façade 651 that describes OU-A in solution community 601; OU-D owns a façade 653 that describes OU-A in solution community 602; and OU-A owns a façade 661 that describes OU-B in solution community 603 and a façade 671 that describes OU-D in solution community 603.

Subsequent to forming a direct relationship with the system, OU-A can gain control of their identity in the overall TP Graph (e.g., by providing information about themselves to the system, for example). By definition, OU-A is an authoritative source of information about OU-A, so they now have the ability to manage the global master data about themselves. The system may update its master data object associated with OU-A to include information about OU-A received from OU-A and/or services provided by the system for OU-A to communicate with OU-B and OU-D.

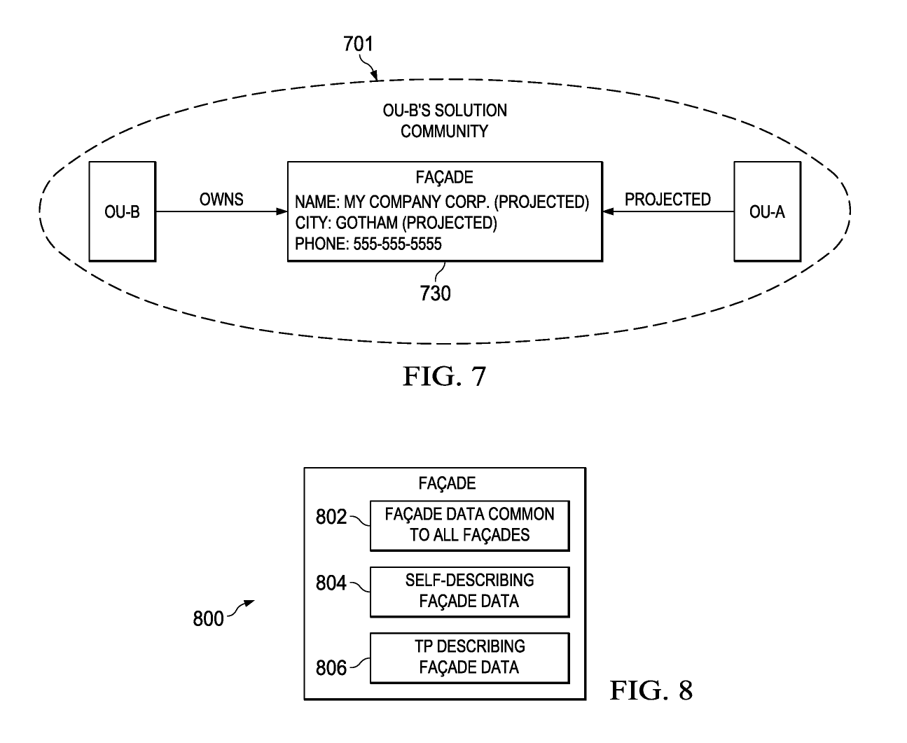

In some embodiments, OU-A can project facts about themselves into their TPs' façades describing them. This is an efficient and effective way of resolving any discrepancy in any façade that describes OU-A. This is illustrated in FIG. 7 where OU-B is the center of a solution community 701 and owns a façade 730 that describes its TP OU-A. In some embodiments, it may be up to façade owners such as OU-B in FIG. 7 to decide if they wish to allow facts to be projected into their façade 730 describing TP OU-A. If allowed, OU-A can project facts about themselves into façade 730 (which is owned by OU-B in solution community 701) that describes them. In some embodiments, OU-B can override a projection made by a TP at an element level (within the façade) or at the façade level. An override of a façade value may be triggered by a request from the OU or TP being described in the façade, by a request from another entity, or by any other means.

Accordingly, an OU who participates in more than one solution community may see substantial differences in façades that describe them from one solution community to the next. Solution communities have differing custom fields, SaaS applications, orchestrated services, security requirements, etc., and these differences may alter the size and scope of the solutions community's façade. Global master data, however, can transcend solution communities.

According to embodiments, master data in a TP Graph can come in two main forms. The first is global master data (e.g., data stored in a master data object), and the second is façade data (e.g., data stored in a façade). Global master data refers to data that can be considered as facts and not likely to be different depending on the solution community context. Global master data should also come from, and be managed by, an authoritative source (usually an associated OU itself).

Examples of global master data include:
Company Name
Unique Identifier (e.g., Routing/EDI address)
Location data
Industry codes (e.g., Standard Industrial Classification or SIC codes, Data Universal Numbering System or DUNS codes, etc.)
Users/Contacts
Partner relationships
Communities configuration

Façade data refers to data that is owned by a solution community owner describing their TPs, and may include data that is owned by a subject TP and projected into the solution community (with permission of the solution community owner). As illustrated in FIG. 8, a façade data structure 800 may include data types 802, 804, and 806.

Data type 802 may be used to describe façade data that is common to all façades and may be characterized by the following aspects:
Community-specific
Can have public and private attributes
Can be tied to a region of a solution community
Can be used to override global master data elements for a specific solution community
Can contain elements needed by SaaS applications (SaaS configuration is solution community specific)
One for each TP in a solution community

Data type 804 may be used to describe façade data that is custom, self-describing (e.g., with data attributes describing an OU/user and their role in a specific solution community as required for configuration, processing and applications of that OU/user in the solution community) and may be characterized by the following aspects:
Created, defined, managed, and owned by the OU/user described.
Used to manage custom attributes specific to a solution community
Solution community owner has a self-describing façade in their own solution community
Can include: X-ref data, solution community specific IDs, legal entity data, etc.

Data type 806 may be used to describe a TP of a solution community owner (e.g., with data attributes describing a TP as required for configuration, processing and applications of that TP in a specific solution community) and may be characterized by the following aspects:
Owned by the solution community owner
Used to manage custom attributes about a TP specific to a solution community
Can include: X-ref data, partner pricing, partner report cards

TP describing façade data may or may not be visible to the TP described.

In some embodiments, façade data structure 800 may further include any global attributes being overridden for a specific solution community and/or any attributes required to describe an OU/user for the purposes of a SaaS application in a specific solution community.

Accordingly, façade data “lives” within a solution community and is not replicated across compute zones as is global master data. This fact allows solution community owners to store data in a façade without having to worry that façade data may be copied outside of the compute zone's region.

In some embodiments, façades can be managed as part of community management. To this end, a system operating on an information exchange platform and implementing a façades architecture disclosed herein may include management interfaces to a communication management tool (application) such that OUs participating in solution communities can maintain/update façade content whenever possible/desired. It might be most efficient to allow TPs to project into a solution's façades as a way to minimize the solution community owner's burden. In some embodiments, façade management can include a determination by the system as to what information to collect. This can be a mixture of defining community specific custom elements, overriding global master data elements, and the automatic inclusion of element blocs related to SaaS applications in a solution.

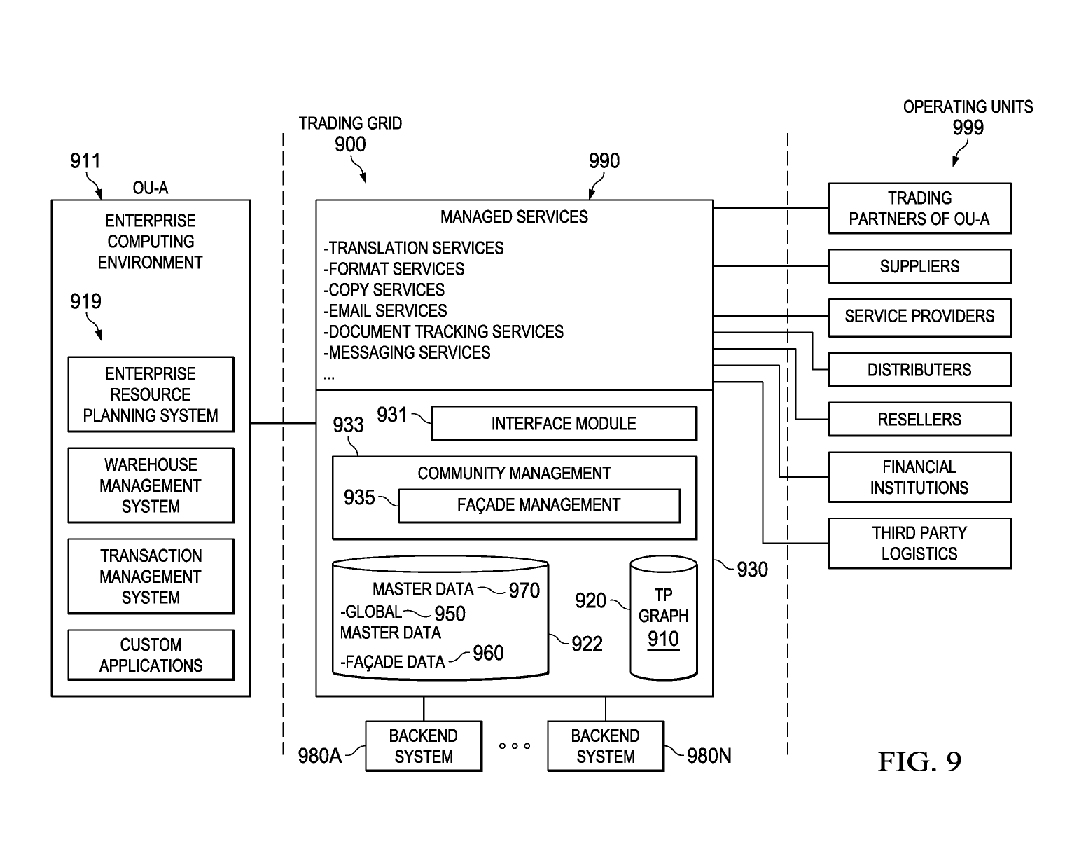

FIG. 9 depicts a diagrammatic representation of an example of an information exchange platform 900 (which, in one embodiment, is referred to as a Trading Grid) having a solution community management system 930. System 930 may be configured to provide and manage (orchestrate) a very large number of services 990 (e.g., 50 or more) performed by backend systems 980A . . . 980N operating on information exchange platform 900.

System 930 may also be configured to provide operating units such as OU-A with access to services 990. As an example, OU-A may own and operate enterprise computing environment 911 which is separate and independent of information exchange platform 900. From the perspective of system 930, OU-A is an enterprise customer and systems 919 of OU-A which utilize services 990 provided by system 930 are client systems of system 930. Client systems 919 operating in enterprise computing environment 911 may use services 990 to communicate with various systems and/or devices operating in computing environments 999 owned and operated by various OUs such as TPs of OU-A. Examples of services 990 may include, but are not limited to, translation services, format services, copy services, email services, document tracking, messaging, document transformation (for consumption by different computers), regulatory compliance (e.g., legal hold, patient records, tax records, employment records, etc.), encryption, data manipulation (e.g., validation), etc.

As a non-limiting example, system 930 may include an interface module 931 configured for providing interfaces to applications executing on information exchange platform 900, including a community management tool 933. As described above, a façade management tool (application) may be part of community management tool 933 through which OU-A can access master data 970 stored in a database 922. Master data 970 may include global master data 950 and façade data 960. Global master data 950 may contain data about OU-A that do not change across solution communities. Façade data 960 may contain community-specific data about OU-A's TPs. System 930 may maintain a TP Graph 910 in a database 920. TP Graph 910 may be a superset of all solution communities defined by system 930 and may include a plurality of nodes, each representing a single OU that may or may not have a direct relationship with system 930.

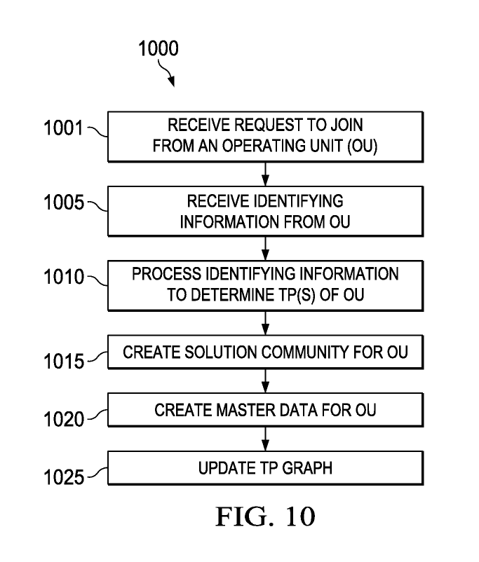

Referring to FIG. 10, in some embodiments, a system such as system 930 may receive a request from a particular OU (e.g., OU-A) wishing to form a direct relationship with system 930 (perhaps it is already a TP of another OU in an existing solution community) (1001). The system may receive identifying information such as a list of EDI addresses from the particular OU (1005). The system may process the identifying information to determine TP(s) of the particular OU (1010). The system may use this information to create a solution community with the particular OU being the center of the solution community (e.g., the particular OU is designated as a solution community owner for the solution community thus created) and connected to the TP(s) determined from the identifying information provided by the particular OU (1015). The system may also create master data associated with the particular OU (1020). This can include creating a master data object for the particular OU and a façade for each of its TP in the solution community. As described above, these façades exist in the solution community, are owned by the particular OU, and reference the same master data object. In some embodiments, the system may create a façade that is specific to the solution community and that describes the particular OU. This allows the particular OU to update their information (e.g., via an interface to a community management tool or a façade management tool) without having to alter the global master data which is managed by the system. Furthermore, the system may update a TP Graph to reflect the correct information about the particular OU, as provided by the OU themselves (1025). For example, the system may process the identifying information received from the particular OU and determine whether any façades in another solution community or other solution communities may need to be updated to reflect the correct information provided by the particular OU. Skilled artisans appreciate that method 1000 described above can be implemented in many ways. For example, not all steps of method 1000 may need to be performed. As another example, the steps of method 1000 may not need to be performed in the order shown in FIG. 10.

In some embodiments of the inventive systems, methods, and techniques described herein, it is a goal to eliminate redundant entities in an entity relationship graph while also preserving entity specific information that is desired and/or needed in separate portions of the entity relationship graph. In such a system, a common entity can be generated to represent common attributes of the redundant entities, while also generating a “façade” for separate portions of the entity relationship graph to preserve the entity specific information. This enables a global efficient view of the entity relationship graph realized by the common entity. However, the global view is transparent to the separate portions of the entity relationship graph, each with their own view, which preserve entity specific information realized by the façades and are tied together by the common entity. Such a system could generate common entities and façades by comparing entities across the entity relationship graph, determining a match between entities (i.e., that the entities are redundant), merging the matched entities into the common entity, and generating façade entities.

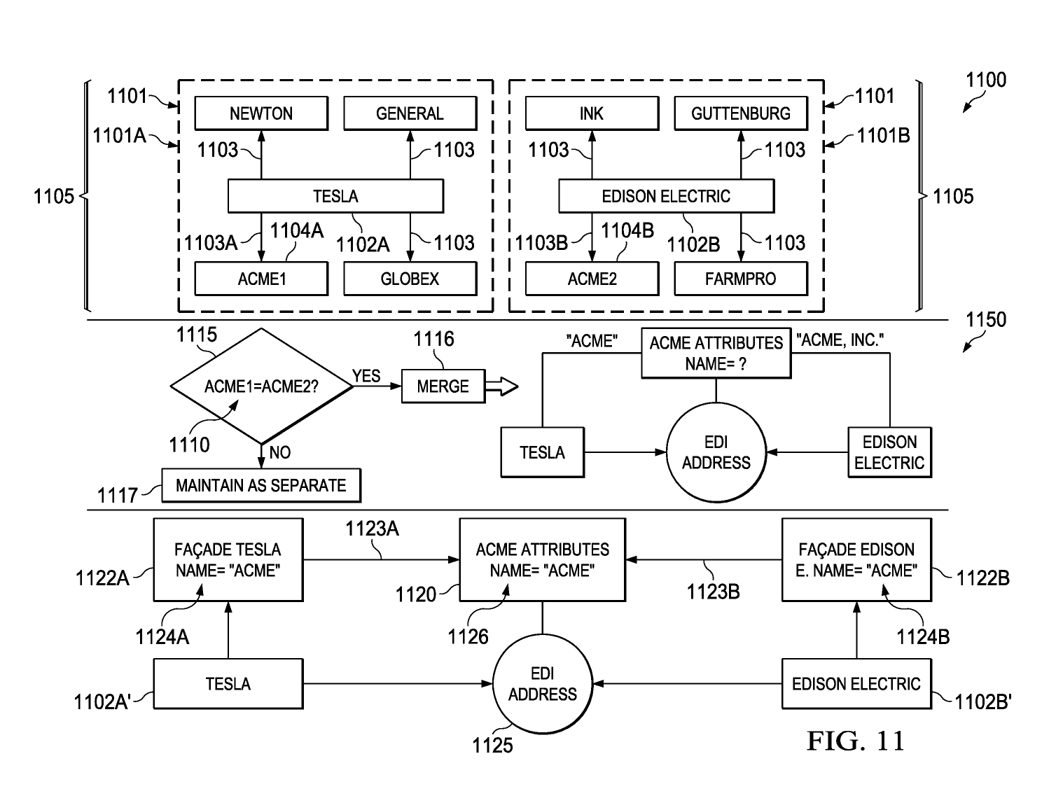

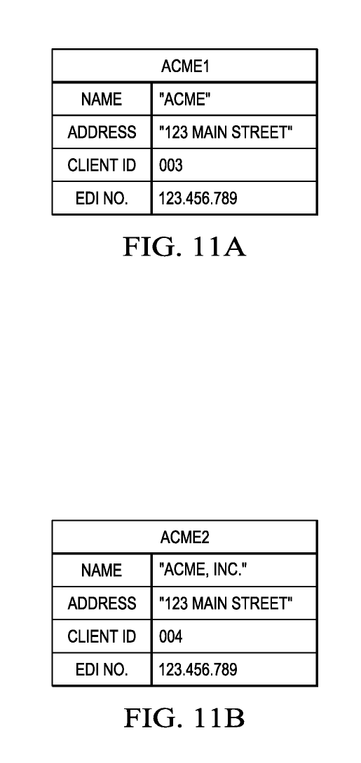

To this end, referring now to FIG. 11, in some embodiments, a system 1100 generates communities 1101 including a first community of entities 1101A and a second community of entities 1101B. Each of the entities has attributes. The first community of entities 1101A includes a first central entity 1102A and a first associated entity 1104A having a relationship (denoted by line 1103A) with the first central entity 1102A, the relationship 1103A defining first computer transactions between the first central entity 1102A and the first associated entity 1104A. The second community of entities 1101B includes a second central entity 1102B and a second associated entity 1104B having a relationship (denoted by line 1103B) with the second central entity 1102B, the relationship 1103B defining second computer transactions between the second central entity 1102B and the second associated entity 1104B.

Entities, generally denoted by reference numeral 1105 (including entities 1102A, 1104A, 1102B, 1104B) have attributes that describe the entities. For example, as shown in TABLE 1, an entity referred to as TESLA may have attributes name, address, client ID, etc. In this example, name and address attributes are text strings, and client ID is an integer. It should be noted that the set of attributes described here are merely exemplary as an entity may include any number and type (for example, text string, integer, decimal, array, etc.) of attributes based on the needs of the system.

TABLE 1
TESLA

| Name | “TESLA” |
|---|---|
| Address | “3 Pleasant Street” |
| Client ID | 001 |

Communities 1101 include any number of related entities 1105. As can be seen in FIG. 11, for example, community 1101A, in one non-limiting embodiment, includes entities named TELSA, GENERAL, NEWTON, ACME1, and GLOBEX. Communities 1101 each define a set of relationships between a central entity (for example, entity 1102A or entity 1102B) and one or more associated entities (for example, for central entity 1102A, associated entities GENERAL, NEWTON, ACME1, and GLOBEX, and for central entity 1102B, associated entities INK, GUTTENBURG, ACME2, and FARMPRO). It should be noted that even though two communities 1101A and 1101B are shown in FIG. 11, system 1100 may generate any number of communities 1101 as needed or desired.

Communities 1101 may be represented in system 1100 using a variety of techniques. For example, communities 1101 may be represented by a relational database in which entities 1105 are represented as records, attributes are represented as columns, and communities are defined by corresponding unique IDs stored with entities 1105. The database further represents the linkages (i.e., relationships 1103) between entities 1105. Other methods may be employed, such as linked lists, arrays, and/or graph databases.

Relationships (generally denoted by reference numeral 1103) between entities 1105 facilitate computer transactions (also referred to as computer-to-computer interchange of formatted messages) that occur between entities 1105. In some embodiments, computer transactions include, but are not limited to, customer orders, invoicing, and/or information messaging. In one non-limiting example, a relationship between TELSA (1102A), a customer, and ACME1 (1104A), a vendor, facilitates a customer order where TELSA orders mechanical parts from vendor ACME1 using information such as ACME1's client ID to process and communicate the order to ACME1. As a whole, relationships 1103 facilitate computer transactions between and among entities 1105 of a community 1101, based on attributes defined for each of entities 1105.

System 1100 compares the first associated entity 1104A of the first community 1101A with the second associated entity 1104B of the second community 1101B and, based on the comparison, determines that the first associated entity 1104A and the second associated entity 1104B have matching attribute pairs. In some embodiments, system 1100 compares at least one of the attributes of the entities 1105. For example, referring to TABLE 1, system 1100 may compare the name attribute of the first associated entity 1104A and the name attribute of the second associated entity 1104B, the address attribute of the first associated entity 1104A and the address attribute of the second associated entity 1104B, and so on.

In one non-limiting example, referring to FIG. 11A and FIG. 11B, and again to FIG.11, entity ACME1 1104A has the name “ACME” and address “123 MAIN STREET”, and entity ACME2 1104B has the name “ACME, INC.” and address “123 MAIN STREET.” System 1100 compares (denoted by comparison diamond 1110) the name and address attributes of entities 1104A, 1104B and determines that they have the same address attribute values “123 MAIN STREET”, which may be accomplished by performing a text string comparison. System 1100 further compares the name attribute values and determines, however, that name attribute values are not the same. However, the only difference is that the name attribute value for ACME2 further includes the substring “, INC.”

In a further representative embodiment, system 1100 may resolve attribute value discrepancies by preprocessing attribute text strings to remove stop words or certain words or substrings such as “A”, “THE”, and “INC.” In this way, system 1100 may remove the substring “, INC.” from ACME2's name attribute value and so result in an exact matching between the name attributes values for ACME1 and ACME2. In a representative embodiment, system 1100 may store strings for the original value “ACME, INC.” and the processed value “ACME”, the processed value to be used in matching, while preserving the original value for the community.

In another representative embodiment, system 1100 may perform string comparisons and determine that the text string values match if a certain percentage of the string characters match, for example, 80%. In still another representative embodiment, system 1100 includes a list of predefined attribute values. If the compared attribute values both contain one of the predefined attribute values (such as ACME), system 1100 determines that there is a match.

System 1100, based on the foregoing determination, either maintains (1117) first associated entity 1104A and second associated entity 1104B as separate entities 1105 or merges (1116) first associated entity 1104A and second associated entity 1104B into a master common entity 1120 as will be discussed in further detail hereinafter. System 1100 may use a variety of methods and approaches (1115) to determine a match between first associated entity 1104A and second associated entity 1104B. For example, system 1100 may perform pairwise comparisons between one or more of the entity attribute values (see above) and, if a certain number of them match, determine that the entities match. The match determination may be based on a confidence level and/or a threshold. For example, if two out of three attribute value strings match, then system 1100 determines that the entities match. Here, the confidence value would be two out of three matching values or 66% percent. One of ordinary skill in the art would readily recognize that many different types of matching algorithms may be employed for match determinations.

In one representative embodiment, system 1100 performs the entity comparisons when a new entity is defined in one of the communities. Here, system 1100 may compare the new entity with each of the existing entities in other communities, or even within the same community in case of an inter-community redundancy. System 1100 may also periodically perform entity comparisons between every possible pair of entities, or a subset thereof. In still other representative embodiments, the determination occurs when a product with a unique ID and offered by only a single entity is bought/sold in the communities, thus indicating that there is likely a match between entities.

In some embodiments, upon a match, system 1100 merges (1116) the first associated entity 1104A with the second associated entity 1104B by generating a master common entity 1120. The master common entity 1120 has a relationship 1123A with the first central entity 1102A′, the relationship 1123A between entities 1102A′, 1120 facilitates computer transactions that occur between entities 1102A′, 1120, such computer transactions including at least a portion of the computer transactions 1103A. Further, master common entity 1120 has a relationship 1123B with the second central entity 1102B′, the relationship 1123B between entities 1102B′, 1120 facilitates computer transactions that occur between entities 1102B′, 1120, such computer transactions including at least a portion of the computer transactions 1103B.

In some embodiments, system 1100 generates a first façade entity 1122A including at least one attribute 1124A of the first community of entities 1101A, the first façade entity 1122A referencing the first central entity 1102A and the master common entity 1120. System 1100 further generates a second façade entity 1122B including at least one attribute 1124B of the second community of entities 1101B, the second façade entity 1122B referencing the second central entity 1102B and the master common entity 1120. In a further embodiment, the first façade entity 1122A includes an attribute 1124A of the first community of entities 1101A. The attribute 1124A may include community specific information referenced or stored in the first façade entity 1122A. In one non-limiting example, the attribute 1124A may include the name of the first associated entity 1104A prior to its merge into the master common entity 1120, here, for ACME1, the name attribute value “ACME” for the first associated entity 1104A. Similarly, the second façade entity 1124B may include the name of the second associated entity 1104B prior to its merge into the master common entity 1120, here, for ACME2, the name attribute value “ACME, INC.” for the second associated entity 1104A.

In some embodiments, master common entity 1120 includes attributes 1126 based on a merging of the first associated entity 1104A and the second associated entity 1104B common to the entities. A variety of methods may be used to perform the merge. For example, in one non-limiting example, system 1100 compares corresponding attribute values and, if they are equal, generates a new master common entity attribute field with the attribute values. However, as designed by the “merge problem” denoted by reference numeral 1150, it may be the case that attribute values are not the same, and system 1100 needs to determine how to combine the different values into one master common entity attribute 1126. For example, one of the values may be “ACME” and the other “ACME, INC.” System 1100 may determine that the substring “, INC.” is superfluous and may combine “ACME” and “ACME, INC.” by ignoring “, INC.” and generating the name attribute value “ACME” 1126 in master common entity 1120.

In some embodiments, an electronic data interchange (EDI) address is used to send/receive computerized transactions between the entities 1105. In some instances, entities 1105 include an EDI address attribute and the first associated entity 1104A and the second associated entity 1104B may have the same EDI address. This may be the case where entities have unique EDI addresses designated by a source outside the system 1100. In this case, in one embodiment, system 1100 uses the EDI addresses to compare first associated entity 1104A and second associated entity 1104B and determine that if they match and, if so, merge the first associated entity 1104A and the second associated entity 1104B. Here, master common entity 1120 would be assigned the unique EDI address 1125.

In further embodiments, first associated entity 1104A and second associated entity 1104B may have different EDI addresses. In such a case, system 1100 needs to determine which EDI address to use when generating the master common entity 1120. A variety of methods may be used. For example, in one non-limiting embodiment, system 1100 may arbitrarily use one of the EDI addresses and create a mapping between it and the other EDI address.

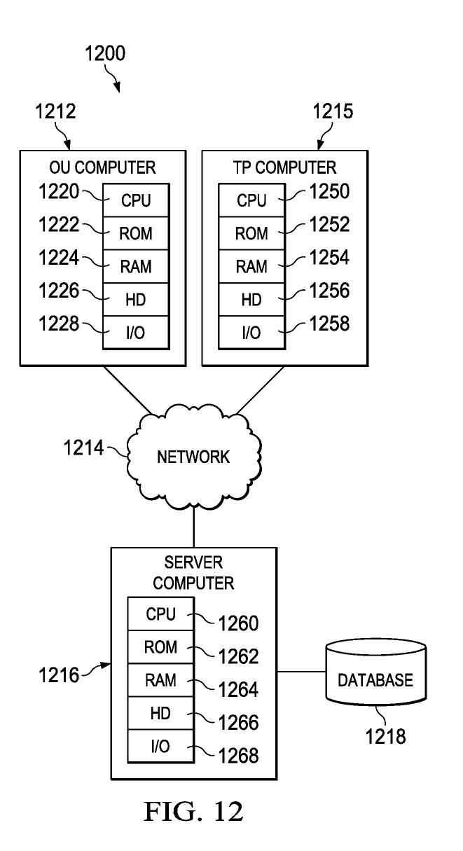

FIG. 12 illustrates an exemplary architecture for network computing environment 1200 that includes network 1214 that can be bi-directionally coupled to OU computer 1212, TP computer 1215, and TG server computer 1216. TG server computer 1216 can be bi-directionally coupled to database 1218. Network 1214 may represent a combination of wired and wireless networks that network computing environment 1200 may utilize for various types of network communications known to those skilled in the art.

For the purpose of illustration, a single system is shown for each of OU computer 1212, TP computer 1215, and TG server computer 1216. However, within each of OU computer 1212, TP computer 1215, and TG server computer 1216, a plurality of computers (not shown) may be interconnected to each other over network 1214. For example, a plurality of OU computers 1212 and a plurality of TP computers 1215 of their TPs may be coupled to network 1214. OU computers 1212 may include data processing systems for communicating with TG server computers 1216. TG server computers 1216 may include data processing systems configured for providing services, community management, and/or façade management to OU computers 1212.

As a non-limiting example, OU computer 1212 can include central processing unit (“CPU”) 1220, read-only memory (“ROM”) 1222, random access memory (“RAM”) 1224, hard drive (“HD”) or storage memory 1226, and input/output device(s) (“I/O”) 1228. I/O 1229 can include a keyboard, monitor, printer, electronic pointing device (e.g., mouse, trackball, stylus, etc.), or the like. OU computer 1212 can include a desktop computer, a laptop computer, a personal digital assistant, a cellular phone, or nearly any device capable of communicating over a network. TP computer 1215 may be similar to OU computer 1212 and can comprise CPU 1250, ROM 1252, RAM 1254, HD 1256, and I/O 1258.

Likewise, TG server computer 1216 may include CPU 1260, ROM 1262, RAM 1264, HD 1266, and I/O 1268. TG server computer 1216 may include one or more backend systems configured for providing a variety of services to OU computers 1212 over network 1214. One example of such a backend system can be a database management system for database 1218. Many other alternative configurations are possible and known to skilled artisans.

Each of the computers in FIG. 12 may have more than one CPU, ROM, RAM, HD, I/O, or other hardware components. For the sake of brevity, each computer is illustrated as having one of each of the hardware components, even if more than one is used. Each of computers 1212, 1215, and 1216 is an example of a data processing system. ROM 1222, 1252, and 1262; RAM 1224, 1254, and 1264; HD 1226, 1256, and 1266; and database 1218 can include media that can be read by CPU 1220, 1250, or 1260. Therefore, these types of memories include non-transitory computer-readable storage media. These memories may be internal or external to computers 1212, 1215, or 1216.

Portions of the methods described herein may be implemented in suitable software code that may reside within ROM 1222, 1252, or 1262; RAM 1224, 1254, or 1264; or HD 1226, 1256, or 1266. In addition to those types of memories, the instructions in an embodiment disclosed herein may be contained on a data storage device with a different computer-readable storage medium, such as a hard disk. Alternatively, the instructions may be stored as software code elements on a data storage array, magnetic tape, floppy diskette, optical storage device, or other appropriate data processing system readable medium or storage device.

Those skilled in the relevant art will appreciate that the invention can be implemented or practiced with other computer system configurations, including without limitation multi-processor systems, network devices, mini-computers, mainframe computers, data processors, and the like. The invention can be embodied in a general purpose computer, or a special purpose computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines. Examples of a non-transitory computer readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise (i.e., that the reference “a” or “an” clearly indicates only the singular or only the plural). Also, as used in the description herein, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A system, comprising:
at least one processor;
at least one non-transitory computer readable medium; and
stored instructions embodied on the at least one non-transitory computer readable medium and translatable by the at least one processor to:
receive a request from an operating unit, the request containing identifying information;
process the identifying information to determine at least one trading partner of the operating unit;
create a solution community containing the operating unit and the at least one trading partner of the operating unit, with the operating unit designated by the system as an owner of the solution community;
create master data associated with the operating unit, the master data including a master data object for the operating unit and a façade for each of the at least one trading partner of the operating unit in the solution community, the façade referencing the master data object, describing the at least one trading partner of the operating unit in context of the solution community, and including configuration information specific to the solution community and required for computer-to-computer interchange of formatted messages between the operating unit and the at least one trading partner; and
update a trading partner graph stored in a database, the master data object representing the operating unit in the trading partner graph, the trading partner graph containing solution communities and nodes representing operating units and relationships amongst the operating units with respect to the solution communities.

2. The system of claim 1, wherein the identifying information comprises at least one unique identifier of a trading partner of the operating unit.

3. The system of claim 2, wherein the unique identifier comprises an electronic data interchange (EDI) address.

4. The system of claim 1, wherein the master data comprises global master data and façade data, wherein the global master data do not change across the solution communities, and wherein the façade data are community-specific.

5. The system of claim 1, wherein the stored instructions are further translatable by the at least one processor to determine whether any façades in any of the solution communities need to be updated to reflect information about the operating unit provided by the operating unit.

6. The system of claim 5, wherein the stored instructions are further translatable by the at least one processor to project the information about the operating unit provided by the operating unit into a façade that is in a second solution community, that is owned by a trading partner of the operating unit, and that describes the operating unit in the second solution community from a perspective of the trading partner of the operating unit.

7. The system of claim 1, wherein the stored instructions are further translatable by the at least one processor to create a façade in the solution community that is owned by the operating unit and that describes the operating unit.

8. The system of claim 1, wherein the stored instructions are further translatable by the at least one processor to override a value contained in the façade.

9. The system of claim 8, wherein the override is triggered by a request from an operating unit or trading partner being described in the façade.

10. A system, comprising:
at least one processor;
at least one non-transitory computer readable medium; and
stored instructions embodied on the at least one non-transitory computer readable medium and translatable by the at least one processor to:
generate a first community of entities and a second community of entities, each of the entities having attributes, the first community of entities comprising a first central entity and a first associated entity having a relationship with the first central entity, the relationship defining first computer transactions between the first central entity and the first associated entity, the second community of entities comprising a second central entity and a second associated entity having a relationship with the second central entity, the relationship defining second computer transactions between the second central entity and the second associated entity;
compare the first associated entity of the first community with the second associated entity of the second community and, based on the comparison, determine that the first associated entity and the second associated entity have matching attribute pairs;
based on said determination, generate a master common entity by merging the first associated entity with the second associated entity, the master common entity having a relationship with the first central entity comprising at least a portion of the first computer transactions, and a relationship with the second central entity comprising at least a portion of the second computer transactions;
generate a first façade entity comprising at least one attribute of the first community of entities, the first façade entity referencing the first central entity and the master common entity; and
generate a second façade entity comprising at least one attribute of the second community of entities, the second façade entity referencing the second central entity and the master common entity, the master common entity comprising attributes based on said merging of the first associated entity and the second associated entity.

11. The system of claim 10, wherein the first and second computer transactions comprise computer-to-computer interchange of formatted messages.

12. The system of claim 10, wherein the stored instructions embodied on the at least one non-transitory computer readable medium and further translatable by the at least one processor to:
compare the attributes of the first associated entity and the second associated entity; and
determine that attributes are the same.

13. The system of claim 12, wherein the attributes include text strings, wherein comparing the attributes comprises comparing the text strings, and wherein determining that attributes are the same comprises determining that a portion of the text strings are the same.

14. The system of claim 10, wherein the associated entities each have a network address and the comparison comprises:
comparing the network addresses of the first associated entity and the second associated entity; and
determining that the network addresses are the same.

15. The system of claim 10, wherein each of the entities is assigned a unique identifier and the first computer transactions and the second computer transaction occur according to the unique identifier.

16. The system of claim 15, wherein the unique identifier comprises an electronic data interchange (EDI) address.

17. The system of claim 10, wherein the stored instructions embodied on the at least one non-transitory computer readable medium and further translatable by the at least one processor to:
merge the first associated entity and the second associated entity by performing a comparison of a first attribute of the first associated entity to a second attribute of the second associated entity, the second attribute corresponding to the first attribute; and
generate an attribute of the master common entity based on said comparison.

18. The system of claim 17, wherein the stored instructions embodied on the at least one non-transitory computer readable medium and further translatable by the at least one processor to:
copy the first attribute to the first façade entity and the copy the second attribute to the second façade entity, thereby preserving each attribute, the first attribute and the second attribute being different, and the attribute of the master common entity representing a merged common attribute corresponding to the first attribute and the second attribute.

19. The system of claim 17, wherein generating an attribute of the master common entity comprises omitting a portion of the first attribute or the second attribute.

20. The system of claim 10, wherein determining that the first associated entity and the second associated entity have matching attribute pairs comprises referencing a list of predefined attribute values.
